(19) United States
(12) Patent Application Publication
(10) Pub. No.: US 2023/0129115 A1
(43) Pub. Date: Apr. 27, 2023

(54) SENSOR-ENABLED RANGE HOOD SYSTEM AND METHOD

(71) Applicant: Broan-NuTone LLC, Hartford, WI (US)

(72) Inventors: Richard R. Sinur, West Bend, WI (US); Brian R. Wellnitz, Grafton, WI (US); Richard J. Palmersheim, Mequon, WI (US)

(73) Assignee: Broan-NuTone LLC, Hartford, WI (US)

(21) Appl. No.: 14/267,618

(22) Filed: May 1, 2014

Related U.S. Application Data
(60) Provisional application No. 61/819,438, filed on May 3, 2013.

(51) Int. Cl. F24C 15/20; A47J 27/62

(52) U.S. Cl. CPC F24C 15/2021; A47J 27/62

(57) ABSTRACT

A sensor-enabled range hood can be used with a cooking appliance. Information from multiple sensors can be used to determine whether abnormal or hazardous conditions are present, such as when unattended cooking is detected. A local indication or a remote notification can be generated in response to one or more conditions. A control signal to control a cooking appliance or range hood can be issued in response to one or more conditions. A remediation signal to address an actual fire present can be issued, such as to trigger fire remediation.

### CLAIM OF PRIORITY

This patent application claims the benefit of priority of U.S. Provisional Patent Application Ser. No. 61/819,438, entitled “SENSOR-ENABLED RANGE HOOD SYSTEM AND METHOD” filed on May 3, 2013 (Attorney Docket No. 001083-053900), which is hereby incorporated by reference herein in its entirety.

### BACKGROUND

Kitchen fires are the number one source of residential home fires, and unattended cooking is the leading cause of kitchen fires. Kitchen fire risk is seen by regulators and insurers as a major problem. Most residential building codes attempt to address this issue by requiring the use of smoke alarms placed in and around the kitchen. One major issue with the use of smoke alarms in the kitchen environment is related to “false triggering” during a smoky cooking event. If a consumer experiences multiple false triggering events, the consumer may relocate the alarm further away from the kitchen/cooking area. By locating the alarm further away from the cooking source, the response time of the alarm could be unacceptably lengthened, potentially putting property and life at additional risk. Furthermore, certain smoke alarms (e.g., optical or ionization) only react to smoke, and do not provide adequate monitoring or sensing that could help to predict when a kitchen fire is imminent.

The present inventors have recognized, among other things, that a system and product that address this very real and severe problem of kitchen fires, such as including through early detection at or near the point of origin, would be a recognizable benefit to consumers.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an illustration showing examples of various sensors or controls that can be used in or with the present sensor-enabled range hood system or method.

FIG. 2 is an illustration showing examples of a tiered condition determination or response.

FIG. 3 is an illustration showing an example of portions of a sensor-enabled range hood system.

FIG. 4 is an illustration showing an example of a tiered condition determination or response technique, such as can be performed using a sensor-enabled range hood system, such as that shown in FIG. 3.

### DETAILED DESCRIPTION

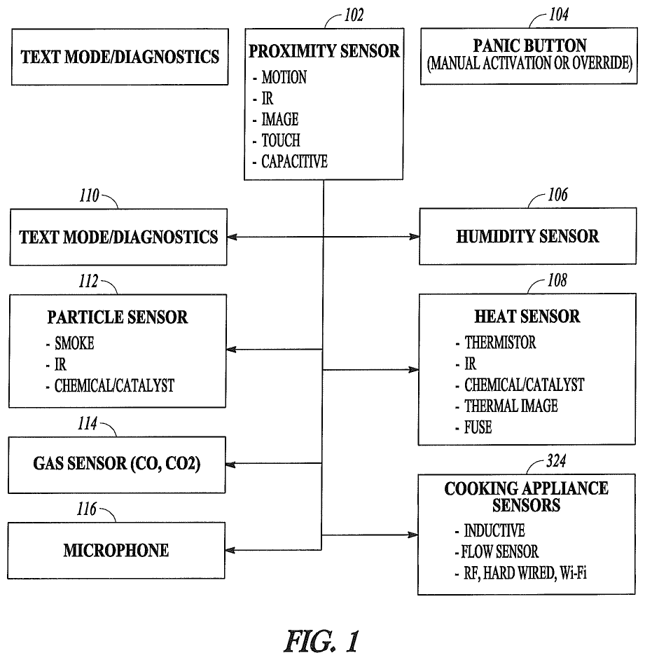

In an example, the systems and methods can include one or more components that can be located, or steps that can be performed, in or near a cooking area, such as in a kitchen. For example, one or more sensors in one or more sensor configurations (e.g., such as shown in FIG. 1) can form part of a sensor-enabled range hood system, such as by being included in the range hood, a cooking appliance, or elsewhere. The sensor-enabled range hood system can include or can be used with a range system that can include, for example, a gas range system, an electric range system, a halogen range system, an inductive range system, an infra-red range system, a microwave range system, or a combination range system (e.g., a range system that can use any one or combination of the foregoing range systems). Further, one or more of the components described herein can be integrated into an over-the-range hood, such as an over-the-range microwave hood (e.g., an over-the-range microwave oven including an over-the-range exhaust hood).

During operation, for example, when the sensor-enabled range top features multiple cooking surfaces, or during multiple sequential or prolonged cooking episodes, or when cooking certain types of foods, the sensor-enabled range hood may be exposed to high temperatures. The sensor-enabled range hood outer surface and internal components may be heated such as by convection, infra-red heat, or from steam, hot gases and cooking effluent, or may be operated in an environment with a high ambient temperature. In some instances, the sensor-enabled range hood outer surface or internal components may be heated by a fire or over-heated food on one or more cooking surfaces of the sensor-enabled range top. In some circumstances, the sensor-enabled range hood outer surface or internal components may be heated by a fire from a foreign material or object on one or more cooking surfaces of the sensor-enabled range top (for example, a cooking utensil, wash-cloth, clothing, plastic food container, or other material).

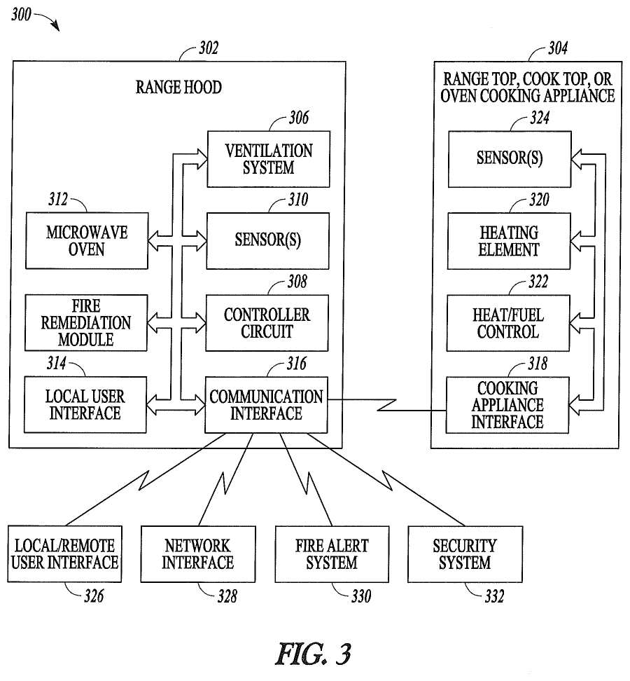

The sensors and sensor configurations shown in FIG. 1 can form part of a sensor-enabled range hood system 300, an example of which is shown in FIG. 3. The sensor-enabled range hood system can include or be coupled to at least one control system. In an example, one or more of the sensors or sensor control components can be located immediately adjacent to, within, or above a cooktop or range top. Accordingly, although the description herein includes examples of components of the sensor-enabled range hood system installed within a region of a kitchen, this description is not intended to limit the scope of this disclosure to kitchen or cooking-related applications.

In an example, the sensor-enabled range hood system can include at least one proximity sensor 102, such as can be used to detect the presence or absence of a user, such as at or near the range or at or near the kitchen. The at least one proximity sensor can include a motion sensor. In an example, the proximity sensor can include an infra-red radiation sensor, such as can be configured to detect infra-red radiation emitted by a user. In an example, the infra-red radiation sensor can additionally or alternatively be configured to detect one or more levels of infra-red radiation emitted by a cooking element or a cooking utensil, or emitted from an enclosed or other cooking region of the sensor-enabled range hood system (for example, within an oven). In an example, the infra-red radiation sensor can additionally or alternatively be configured to detect infra-red radiation emitted from a range top cooking surface, configured to detect the presence or absence of an object such as a cooking utensil on a the range top surface, the infra-red profile or temperature of the cooking surface or utensil, or the presence or absence of an ignition source or a material about to ignite, igniting, or undergoing combustion.

In an example, the one or more proximity sensors can include an image sensor, such as for example a photo-diode array or a charge-coupled device, or other digital imaging sensor 110. For example, the image sensor can be configured to image a user (e.g., to allow the control system to determine the presence or absence of a user, such as in or near a specified space). The image sensor can additionally or alternatively be configured to image a cooking element or a cooking utensil. For example, an image sensor can be configured to image an enclosed cooking region of the sensor-enabled range hood system (for example, a region of an oven). The image sensor can additionally or alternatively be configured to detect a range top cooking surface, such as to detect one or more of the presence or absence of an object such as a cooking utensil on a the range top surface, the infra-red profile or temperature of the cooking surface or utensil (e.g., if the image sensor is sensitive to infra-red wavelengths), or the presence or absence of an ignition source or a

material about to ignite, igniting, or undergoing combustion). In an example, the image sensor can be configured to detect a material undergoing an exothermic reaction, such as one or more of pre-ignition, ignition, or combustion.

In an example, the system can include a touch or capacitive sensor. The touch or capacitive sensor can be configured as a proximity sensor, such as to detect a user, or can additionally or alternatively be configured to detect a cooking utensil. In an example, a touch or capacitive sensor can be configured to detect the presence or absence of an object, such as a cooking utensil on a range top surface.

In an example, one or more proximity sensors can additionally or alternatively be configured for one or more other purposes, such as to detect the presence or absence of an object such as on or within the vicinity of one or more cooking elements such as within the sensor-enabled range hood system. For example, one or more proximity sensors can be configured to detect the presence or absence of an object such as a cooking utensil (for instance, a cooking pot or a frying pan, etc.). In some embodiments, one or more proximity sensors can be used to detect the presence or absence of an object, such as a cooking utensil, such as on a range top cooking surface. In an example, one or more proximity sensors can be used to detect the presence or absence of an object, such as a cooking utensil, such as within an enclosed cooking region of or adjacent the sensor-enabled range hood system (for example, within an oven).

In an example, the sensor-enabled range hood system can include at least one panic button 104. The panic button can include manual activation or override of at least one function of the sensor-enabled range hood system. In an example, a user can turn off at least one heating element of the sensor-enabled range hood system, such as by activating the panic button. In an example, a user can additionally or alternatively turn on or turn off at least one audible alarm of the sensor-enabled range hood system such as by activating the panic button. In an example, the system can include a panic button such as can be configured to turn on one or more local or remote elements of a fire alarm or fire suppression system.

The sensor-enabled range hood system can include at least one particulate sensor (“particle sensor”) 112. The particulate sensor can be configured to detect a particulate cloud, such as smoke or other particulate material such that emitted from a material igniting or undergoing oxidative combustion. In an example, a particulate sensor can be configured to detect a particulate cloud, such as smoke or other particulate material such as that emitted from a material undergoing non-oxidative combustion or pyrolysis. The particulate sensor can include a digital imaging sensor such as can be configured to detect a particulate cloud by imaging and by image analysis, such as within a control system of the sensor-enabled range hood system. As mentioned

previously, an infra-red sensor can also be included. In an example, the infra-red sensor can additionally or alternatively be configured to detect a particulate cloud, such as smoke or other particulate material emitted from a material undergoing oxidative combustion, non-oxidative combustion, or pyrolysis, or to distinguish or help distinguish between these sources of the particulate cloud.

In an example, the particulate sensor can include at least one chemical sensor, such as can be configured for detecting at least one or more products of oxidative combustion, one or more products of non-oxidative combustion, or one or more products of pyrolytic decomposition, or to distinguish or help distinguish between these. In an example, the particulate sensor can additionally or alternatively include one or a plurality of chemical sensors that can be located or distributed within the sensor-enabled range hood system. In an example, a plurality of chemical sensors can be configured to detect the same chemical species or to detect a different chemical species. In an example, the one or more chemical sensors can include a gas sensor 114 that can be configured to detect at least one non-flammable gas, such as a specified at least one of carbon monoxide, carbon dioxide, or one or more mixtures thereof.

In an example, the at least one chemical sensor can be configured to be capable of detecting a specified at least one of an oil or grease oxidative degradation product, an oil or grease non-oxidative degradation product, an oil or grease pyrolysis product, or an oil or grease vapor or fluid, or one or more mixtures thereof.

In an example, the at least one chemical sensor can be configured to be capable of detecting a specified at least one of a carbohydrate oxidative degradation product, a carbohydrate non-oxidative degradation product, or a carbohydrate pyrolysis product, or one or more mixtures thereof.

In an example, the sensor-enabled range hood system can include at least one chemical sensor that can be configured to be capable of detecting a specified at least one of a protein oxidative degradation product, a protein non-oxidative degradation product, or a protein pyrolysis product, or one or more mixtures thereof.

In an example, the sensor-enabled range hood system can include at least one chemical sensor that can be configured to be capable of detecting degradation of a cellulosic based material (for example, from a clothing or kitchen cloth or towel product). For example, the sensor-enabled range hood system can include at least one chemical sensor that can be configured to be capable of detecting a specified at least one of a cellulose oxidative degradation product, a cellulose non-oxidative degradation product, or a cellulose pyrolysis product, or one or more mixtures thereof.

In an example, the sensor-enabled range hood system can include at least one chemical sensor that can be configured to be capable of detecting degradation of a polymeric product (for example, a plastic utensil or kitchen container, or some portion of the housing of the sensor-enabled range hood system). For example, the sensor-enabled range hood system can include at least one chemical sensor that can be configured to be capable of detecting a oxidative degradation product such as from at least one of a nylon, a polyurethane, a polyethylene, a polypropylene, a polycarbonate, a polyester, or one or more copolymers or mixtures thereof. In an example, the sensor-enabled range hood system can include at least one chemical sensor that can be configured to be capable of detecting a detecting a non-oxidative degradation product such as from at least one of a nylon, a polyurethane, a polyethylene, a polypropylene, a polycarbonate, a polyester, or one or more copolymers or mixtures thereof. In an example, the sensor-enabled range hood system can include at least one chemical sensor that can be configured to be capable of detecting a pyrolysis product such as from at least one of a nylon, a polyurethane, a polyethylene, a polypropylene, a polycarbonate, a polyester, or copolymers or mixtures thereof.

In an example, the at least one chemical sensor can include a catalyst. For example, the sensor-enabled range hood system can include at least one sensor that can be configured to be capable of detecting a specified one or more products of oxidative combustion, non-oxidative combustion, or pyrolytic decomposition, such as described above, such as by catalytically converting at least one or more products and detecting the converted by-product.

The sensor-enabled range hood system can additionally or alternatively include at least one sound sensor (for instance, a microphone 116). In an example, the sound sensor can be configured to detect or distinguish at least the background noise from the vicinity of the sensor-enabled range hood system. In an example, the sound sensor can be configured to detect or distinguish a user or a background noise. In an example, the sound sensor can be configured to detect or distinguish sound emitted during at least one of a fire, a non-oxidative combustion, or a pyrolytic event. In an example, the sensor-enabled range hood system can include at least one microphone-enabled override of at least one function of the sensor-enabled range hood system. In an example, a user can update, modify, or otherwise control at least one control of the sensor-enabled range hood system such as including through a verbal command. In an example, the system can be configured such that a user can turn off at least one heating element of the sensor-enabled range hood system including by announcing a designated command that is capable of being received by the microphone-enabled override.

The sensor-enabled range hood system can additionally or alternatively include at least one humidity sensor 106. In an example, the at least one humidity sensor can be configured to be capable of detecting or distinguishing water vapor or steam. In an example, the humidity sensor can be configured to detect a change in humidity within the vicinity of the sensor-enabled range hood system. In an example, the humidity sensor can be configured to detect a change in humidity such as that produced as a result of a cooking event. In an example, the humidity sensor can be configured to detect a change in humidity such as that produced as a result of a combustion event, such as a fire.

The sensor-enabled range hood system can additionally or alternatively include at least one heat sensor 108. In an example, the heat sensor can be configured to detect a change in temperature, such as within the vicinity of the sensor-enabled range hood system. In an example, the heat sensor can be configured to detect a change in temperature such as that that can be produced as a result of a cooking event. In an example, the heat sensor can be configured to detect a change in temperature such as that can be produced as a result of a combustion event, such as a fire. In an example, the heat sensor can include a thermistor. As described herein, the heat sensor can include an infra-red sensor of the sensor-enabled range hood system. In an example, the infra-red sensor can include an imaging device, such as described herein. In an example, the heat sensor can comprise a thermally sensitive fuse. In an example, the heat sensor can include a heat sensitive catalyst such as can be configured to produce a sensor-detectable by-product when heated by at least one heat source.

The sensor-enabled range hood system can additionally or alternatively include at least one inductive sensor. For example, the sensor-enabled range hood system can include at least one inductive sensor that can be configured to detect the presence of a cooking utensil. In an example, the inductive sensor can be configured to sense current flowing in at least one inductive heating coil such as can be included in the range top or cooking top.

The sensor-enabled range hood system can include one or more cooking appliance sensors 324, such as a flow sensor, for example, such as can be configured to monitor and optionally control the flow of a combustible gas (for example, the flow of natural gas supplied to at least one cooking element of the sensor-enabled range hood system). In an example, the sensor-enabled range hood system can include a flow sensor that can be configured to monitor the fluid flow through at least one portion of the ventilation system of the sensor-enabled range hood system. In an example, a flow sensor can be included within at least one duct in or coupled to the ventilation system. In an example, the sensor-enabled range hood system can include a flow sensor that can be configured to detect a low flow rate of at least one portion of the ventilation system (for example, due to a blockage or malfunction of the ventilation system.

In an example, such as in order to exhaust at least a portion of a cooking effluent or one or more other fluids produced during a cooking episode, a ventilation assembly can be automatically or manually activated, such as to remove steam, or one or more other gases or one or more odors such as from the cooking area above the range top or one or more areas immediately adjacent to the range top. In an example, the sensor-enabled range hood system can include a ventilation system, which can include a fan and filter system that can be coupled within a housing that can include at least one inlet. The ventilation system can additionally or alternatively include a louver system, such as can be coupled to the fan, and a ducting system, such as can be coupled to the housing. In an example, at least a portion of a gaseous fluid can be moved away from the range top and immediately adjacent areas and pulled through the ventilation system such as via one or more fluid inlets of the ventilation system. The ventilation system can include one or more filters, such as can be located substantially in the ducting system, which can be coupled to the fan. In an example, the ventilation system can include at least one duct (e.g., including at least one fluid outlet) that can be coupled to a location external to the sensor-enabled range hood, such that can direct the exhausted effluent to a desired location (e.g., out of the structure, out of the local environment, or back out of the sensor-enabled range hood following filtration to remove odors and/or particulates, etc.).

In an example, the housing can include a filter interface, which can include or be coupled to a filter change or filtering monitoring system. For example, the housing can include a replaceable filter and at least one system or method for changing the elapsed time since filter install, filter use time since filter install, filter condition indicator, or a combination of one or more of these. In an example, a mechanical indicator can be included and can be configured to alert a user to the need to change one or more filters in the housing. In an example, the filter change indication can be based at least in part on the air flow rate through at least some portion of the ventilation system. In an example, the control system can be configured such that, as the filter becomes clogged over time, the control system can detect the reduction in flow rate through the ventilation system, such as using the flow sensor, which can be coupled to the control system. In an example, the filter system can include an onboard power source, which can be coupled with at least one of a timer circuit or at least one flow control sensor, or both. For example, the filter assembly can include a integrated filter life assembly, such as can include a printed circuit or a printed battery. The printed battery can provide a source of power, such as to a self-contained filter life-time assembly. In an example, the self-contained filter life-time assembly can include an electronic or chemical sensor and control circuitry. In an example, the ventilation assembly can alert a user to a time to replace the filter including the self-contained filter life assembly. In an example, the ventilation assembly can alert a user to a time to replace the filter, e.g., including the self-contained filter life assembly, such as via the controller and user-interface and such as based at least in part on a signal from the electronic or chemical sensor.

The sensor enabled range hood system can additionally or alternatively include a performance management system. In an example, a “before” and “after” indication can be displayed to a user, such as via a graphical or other user interface, as an example of an indicator that can show overall effectiveness of a ventilation event. In an example, the performance management system can be configured to display one or more of various parameters such as can be associated with the cooking episode, including but not limited to, the volume of air extracted, the temperature or humidity levels such as before and after the cooking episode, or an indication of the air quality (e.g., particulate, CO, CO2, hydrocarbons, etc.) before, during, and after the ventilation event.

The housing of the sensor-enabled range hood system can additionally or alternatively include a thermal capture system. For example, some of the heat captured and ordinarily vented from the cooking environment can be at least partially captured by the range hood such as for use to heat the room or space in which the sensor enabled range hood system is located. For example, the ventilation system can include at least one heat exchange assembly. During a cooking episode, heat can be extracted from exhausted effluent and can be passed back into the cooking environment, such as in the form of heated air. In an example, the air can be extracted from the cooking environment and heated, or extracted from an area outside of the cooking area, heated by the outgoing effluent, and then directed into the cooking environment or elsewhere. In an example, moisture can additionally or alternatively be captured from the cooking environment and returned to the cooking environment or directed elsewhere. For example, the housing of the sensor enabled range hood system can include a moisture capture system. In an example, at least some of the moisture ordinarily vented from the cooking environment can be at least partially captured by the range hood, such as can be used to increase the humidity at a desired location, such as the humidity of the room or space in which the sensor enabled range hood system is located. In an example, the ventilation system can include at least one moisture capture and exchange assembly. For example, during a cooking episode, moisture can be extracted from an exhausted effluent, and directed to a desired location, for example, passed back into the cooking environment, such as in the form of moist air. In an example, air extracted from the cooking environment can be used to feed moisture into the cooking environment. In an example, air can be extracted from an area outside of the cooking area, and moisture can be captured such as via the outgoing effluent, and the moisture can be directed toward a desired location, such as by being directed into the cooking environment. In an example, moisture release can be passive, and need not involve forced air. For example, the system can include a moisture capture and exchange assembly that can include one or more moisture exchange media, such as to retain moisture, e.g., from cooking, and to slowly release the moisture back into the room over time. For example, the moisture exchange media can include a desiccant (or similar or other wicking or absorbing material), such as to retain moisture from cooking and then slowly release the moisture back into the room over time.

The sensor-enabled range hood system can include a dynamic air flow management system. For example, the ventilation flow rate or the air flow from an area of the cooktop can be modulated, such as using information from one or more of the various sensors described herein. For example, the dynamic air flow management can be configured to produce an air flow pattern that can be adjusted, such as based at least in part on the specific cookware and placement on the range top or cooktop, such as can be determined using information from one or more of the sensors as described herein.

In an example, the ventilation assembly can be activated (e.g., manually or automatically) such as to generate a fluid flow, such as to exhaust cooking effluent or one or more other gaseous or similar fluids. For example, the ventilation assembly can be configured to generate fluid flow from the inlet (e.g., leading to fluid entering the fluid path) through one or more portions of the ventilation system (e.g., the fluid box). The ventilation system can include one or more fluid outlets, such that at least a portion of the fluid can exit the ventilation system via the one or more fluid outlets. For example, one or more of the fluid outlets can be configured to be in fluid communication with a ventilation network of the structure into which the ventilation system is installed, or can be directly coupled to an exhaust that can direct the exhausted effluent to a desired location (e.g., out of structure, out of the local environment, through a toe-kick of the counter, etc.). Moreover, the ventilation system can additionally or alternatively include one or more filters that can be located along the fluid path, such as to remove at least some portion of the effluent that may be desirous not to exhaust through one or more of the fluid outlets.

The sensor-enabled range hood system can additionally or alternatively include at least one ventilation outlet that can be connected to at least one duct of the sensor-enabled range hood system. The sensor-enabled range hood system can include one or more of: a fan, such as can be mounted or otherwise located within a housing of the sensor-enabled range hood system; a louver system, such as can be coupled to the housing or the fan or both; or a ducting system, such as can be coupled to the housing, the louver system, and the fan. In an example, the system can include or be coupled to a controller that can be configured for controlling a fan motor, such as to remove one or more of steam, one or more gases, or one or more odors, such as via the ducting at a specified rate. In an example, the sensor-enabled range hood system can include one or more components that can include one or more apertures, such as can be configured to provide an aesthetic appearance to the sensor-enabled range hood system. In an example, the one or more apertures can additionally or alternatively provide a fluid connection, such as between the exterior of the sensor-enabled range hood system and at least one internal component of the sensor-enabled range hood system. In an example, one or more of the apertures can be configured so as to fluidly connect the exterior of the sensor-enabled range hood system to internal ducting that can be arranged or otherwise configured to provide a fluid relief pathway. In an example, one or more of the apertures can be arranged or configured such as to fluidly connect the exterior of the sensor-enabled range hood system and at least one internal component of the sensor-enabled range hood system, such as to allow air cooling of one or more components.

The sensor-enabled range hood system can include at least one user interface. In an example, the sensor-enabled range hood system can include at least one user interface that can be coupled to at least one cooking element that is capable of being controlled by a user. For example, the sensor-enabled range hood system can include a housing that can include a graphical or other user interface. The at least one user interface can include one or more switches, buttons, or other control features. In an example, the switches, buttons, or other control features can be configured to provide the user with the ability to control a ventilation assembly (for example to control activation and deactivation or to select one or more of multiple available operational speeds of the ventilation assembly). In an example, the user interface can be configured to provide information or feedback to the user, such as including regarding some aspect of the operational status of the sensor-enabled range hood system. For example, a visual or audio indication can be emitted from a hood of the sensor-enabled range hood system. In an example, the visual indication can be provided through one or more displays (for instance an LCD display) or via one or more indicator lamps. The user interface can include one or more icons, such as can be associated with one or more switches or one or more other user controls, or one or more sensors or sensor control systems. In an example, the one or more icons associated with the one or more switches or other user controls on the user interface can be substantially similar or the same. In an example, the one or more icons associated with the one or more switches or other user controls on the user interface can be substantially different.

In an example, the sensor-enabled range hood system can include at least one user interface that can be configured to include a wireless or wired communication interface, such as can be coupled to an internet or wireless signal such as an RF network. For example, the sensor-enabled range hood system can include at least one wireless transceiver that can be configured to be capable of transmitting at least one signal and receiving at least one signal wirelessly, such as over an internet or other RF network. In an example, the system can be configured such that a user can monitor at least one function of the sensor-enabled range hood system remotely, such as via the wireless transceiver. In an example, a user can monitor at least one function of the sensor-enabled range hood system via the internet or via a cellular phone link. In an example, a user can monitor at least one function of the sensor-enabled range hood system via at least one of a computer, a laptop device, a tablet device, a cellular or other mobile phone, or a smart phone. In an example, a user can control at least one function of the sensor-enabled range hood system via at least one of a computer, a laptop, a tablet, a cellular phone or a smart phone. In an example, the sensor-enabled range hood system can additionally or alternatively be hard-wired to a network, such as an internet, such as via a local-area-network. The sensor-enabled range hood system can additionally or alternatively be coupled to a network, such as an internet, such as via a cable or telephone line. In an example, the system can be configured to enable a user to receive a sensor signal or an alarm remotely (e.g., via a wired or wireless network, such as an internet). In an example, the system can be configured to permit a user to control at least one alarm of the sensor-enabled range hood system remotely (e.g., via a wired or wireless network, such as an internet).

The sensor-enabled range hood system, can include a test or a diagnostics function, for example, a sensor test or a sensor diagnostics function, which can be remotely accessible, such as via an internet or a wireless or RF network).

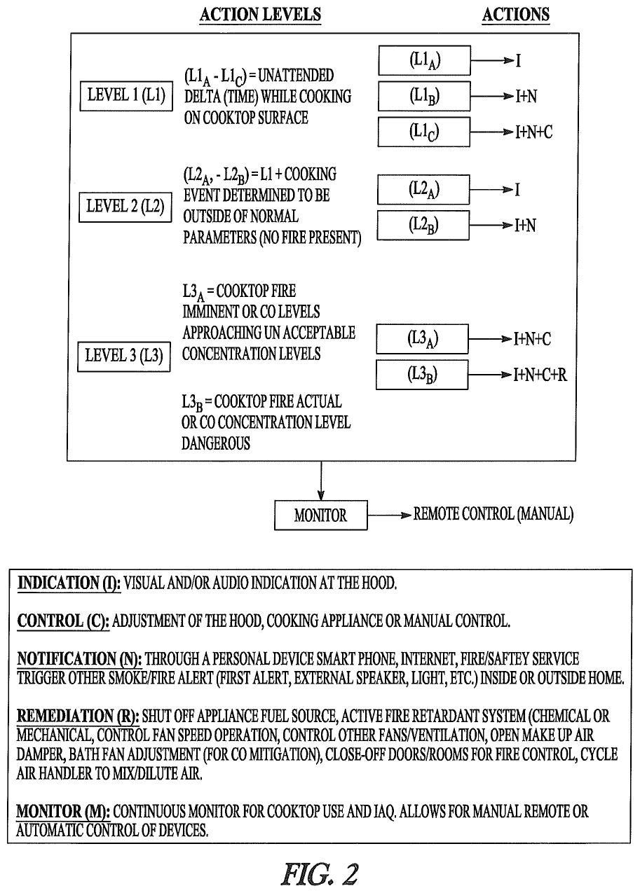

The sensor-enabled range hood system can include at least one control system that can be coupled to at least one sensor. The at least one control system can be configured to be capable of processing at least one sensor signal and performing at least one action based on information from or about the at least one sensor signal. FIG. 2 illustrates an example of action levels and actions of a sensor-enabled range hood sensor system. As shown, the sensor-enabled range hood system can include a plurality of action levels, a plurality of actions, or both. For example, the actions can include “Indication (I)”, “Control (C)”, “Remediation (R)”, and “Monitor (M)”. An example of the descriptions of the actions is provided below, which can be described as follows with respect to a plurality of action levels.

In an example, the action levels and actions can be controlled by a control system. For example, the plurality of action levels can include a level 1 (“L1”), a level 2 (“L2”) and a level 3 (“L3”). One or more of the levels L1, L2, or L3 can include one or a plurality of actions, with each of one or the plurality of actions triggered by one or more level criteria. In an example, an L1 criteria can include unattended delta (time) while cooking on cooktop surface. For example, one or more sensors, such as the digital imaging or other proximity sensors described herein, can be used to determine the presence of a user nearby the cooktop surface, with the controller circuit including a timer circuit that can be configured to measure an elapsed time since the user was last declared present by controller circuit analysis of signal information from the one or more proximity sensors. This elapsed time can be compared to an unattended time threshold value, which can serve as at least one of the L1 criteria.

In an example, one or more L2 criteria can additionally or alternatively be included. For example, the L2 criteria can include an L1 criteria plus conjunctively requiring an indication that a cooking event is determined to be outside of normal parameters (but no fire is present). In an example, based on whether at least one of the level criteria, such as described herein, is met, the sensor-enabled range hood system, controlled by the at least one control system, can initiate at least one action.

In an example, an L1 action can include an “L1_{A}” action. In an example, the L1_{A} action can include the controller circuit triggering a visual or audio indication at the sensor-enabled range hood system, such as at the user interface. In an example, the sensor-enabled range hood system can include or be coupled to at least one loudspeaker or other sound emitting device that can provide an audible indication.

In an example, the L1 action can include an L1_{B} action. The L1_{B} action can include a local visual or audio indication at the sensor-enabled range hood system combined with at least one local/remote notification, such as via a personal device (such as a smart phone). The L1_{B} action can additionally or alternatively include a notification that can be transmitted through a network, such as an internet, or a trigger to a fire/safety service, such as via a home security system or otherwise. The L1_{B} action can additionally or alternatively include a trigger of a smoke/fire alert system (for example, First Alert®, or an external speaker, or other light alarm system) inside or outside of the home. First Alert® is a registered trademark of the First Alert Trust.

In an example, an L1 action can include an “L1_{C}” action. In an example, the L1_{C} action can include the one or more actions as described for an L1_{B} action, combined with at least one control action, such as a range or hood control action, such as such as an adjustment of the sensor-enabled range hood system, the cooking appliance, or manual remote control.

As mentioned earlier, the L2 criteria can include an L1 criteria in conjunction with a cooking event determined to be outside of normal parameters (no fire present). The L2 action can include an “L2_{A}” action. The L2_{A} action can include triggering a visual or audio indication at the sensor-enabled range hood system. In an example, the visual or audio indication can be emitted from a hood of the sensor-enabled range hood system.

In an example, an L2 action can include an “L2_{B}” action. The L2_{B} action can include a local visual or audio indication at the sensor-enabled range hood system combined with at least one local/remote notification such as through a personal device (such as a smart phone). In an example, the L2_{B} action can additionally or alternatively include a notification transmitted through the internet or a trigger to a fire/safety service, such as via a home security system or otherwise. In an example, the L2_{B} action can additionally or alternatively include a trigger of a smoke/fire alert system (for example, First Alert, or an external speaker, or other light alarm system) inside or outside of the home.

In an example, the one or more L3 criteria can include cooktop fire imminent or CO₂ levels approaching unacceptable levels (L3_{A}), or cooktop fire actual or CO concentration level dangerous (L3_{B}). In an example, the one or more L3_{A} criteria can cause an action of the sensor-enabled range hood system that can include one or more control actions as described for L1_{C} such as an adjustment of the sensor-enabled range hood system, the cooking appliance, or manual remote control.

In an example, the L3_{B} action can include one or more actions as described for an L3_{A} action in combination with a remediation action. In an example, the L3_{B} action can include one or more remediation actions such as closing the appliance fuel source, such as can include halting a flow of natural gas to the sensor-enabled range top, turning off the electrical supply to the sensor-enabled range top, initiating an active fire retardant system (such as a chemical or mechanical fire retardant system).

In an example, the L3_{B} action can additionally or alternatively include one or more remediation actions that can include controlling at least one component of the ventilation system. For example, the L3_{B} action can include a remediation action that can include at least one of a control of fan speed operation, control of one or more other fans/ventilation, or the opening or other actuation of a make-up air damper.

In an example, a heat monitoring system can additionally or alternatively be included in the system. For example, the system can include a sensor control system that can include a heat sentry mode. In an example, when a heat sensor detects a specified (e.g., high) level of heat, (e.g., approx. 70° C. at the control board, or at a temperature specified in accordance with a recommendation by the supplier), the heat sentry control system can automatically turn the fan to its highest setting.

The L3_{B} action can additionally or alternatively include a remediation action that can include controlling at least one component of another ventilation system not coupled to the sensor-enabled range hood system. For example, the L3_{B} action can include a remediation action that can include triggering a bathroom fan adjustment (for instance for CO mitigation), a closing of one or more doors/rooms such as for fire control, a control of a cycle air handler to mix/dilute air. In an example, the L3_{B} action can include starting one or more bathroom fans (or other fans in the building) such as to initiate an air exchange within the building. In an example, the L3_{B} action can additionally or alternatively include a remediation action that can include opening one or more make-up air dampers (or other conduits) such as to allow replacement air to flow into the building. In an example, the opening of one or more make-up air dampers (or other conduits) can be combined with starting or adjusting one or more air extraction fans or one or more air handling systems to accelerate air exchange with the building, such as including within a space housing the sensor-enabled range hood.

In an example, the sensor-enabled range hood system can additionally or alternatively include at least one control system that can be coupled to at least one sensor that can monitor an action level and at least one action. In an example, the sensor-enabled range hood system can include at least one control system for controlling and monitoring one or more of various operations of the sensor-enabled range hood. In an example, the user interface can be coupled with at least one monitoring system such as to provide information on at least one functional status of at least one component of the sensor-enabled range hood. In an example, the user interface can be coupled with at least one sensor such as to provide information on the operational status of at least one component of the sensor-enabled range hood system. In an example, the sensor-enabled range hood system can comprise one or more visual indicators that can be included in the user interface such as to communicate to the user the status of one or more components of the sensor-enabled range hood system. In an example, the one or more components of the control system illustrated in FIG. 1 can be coupled to an illumination source or a display forming at least a portion of the user interface. In an example, the sensor-enabled range hood system can include one or more illumination sources. In an example, the one or more illumination sources can be arranged or otherwise configured such as to provide lighting to a range top surface. In an example, the one or more illumination sources can additionally or alternatively be arranged or otherwise configured to provide lighting to an area immediately adjacent to the range top surface. In an example, the one or more illumination sources can additionally or alternatively be arranged or otherwise configured to provide an alert or status to a user. For example, the sensor-enabled range hood system can additionally or alternatively include a user interface with at least one light emitting device (that can for example comprise a light-bulb or incandescent lamp, or a neon-bulb, or a light-emitting diode). In an example, the at least one light emitting device can additionally or alternatively some other visible light emitting device such as can be capable of providing a visual signal to a user of the functional status of one or more components of the sensor-enabled range hood system. In an example, the at least one light emitting device can additionally or alternatively include some other visible light emitting device that can be arranged or otherwise configured to provide a visual signal to a user of the action status of one or more components of the sensor-enabled range hood system.

As shown, the sensor-enabled range hood system can include a plurality of actions levels, such as L1, L2, and L3, one or more of which can include a selected one or a selected plurality of actions, such as described herein, such as where an individual action or plurality of actions can be monitored and controlled by the control system. In an example, any one or more of the actions as described can be monitored and remotely controlled. For example, any one of the actions as described can be monitored and remotely controlled through a remote user interface (for instance, through a remotely positioned computer or laptop or tablet or phone or smartphone, and/or through a web page or other interface). Some embodiments can include a remote upgrade management system. In an example, the control system can include a hardware capability to enable upgradable software, and in an example, the control system comprises upgradeable software. In an example, the upgradeable software can be upgraded remotely (for instance, wirelessly, or via the internet). In an example, the upgradeable software can be upgraded by a user or a service technician. In an example, the upgradeable software can be upgraded to include the latest building code requirements. In an example, the upgradeable software can include the latest building code requirements. In an example, the control system can control the ventilation system such as based at least in part on the upgradeable software that can include the latest building code requirements.

FIG. 3 shows an example of portions of the sensor-enabled range hood system 300, together with portions of an environment in which it can be used. A sensor-enabled range hood 302 can be configured to be located above or near a cooking appliance 304, such as a range top, a cook top, or one or more convection or other ovens. The range hood 302 can include a ventilation system 306, which can include a fluid inlet (e.g., that can be directed toward the cooking appliance), a fluid outlet (e.g., that can be directed locally or additionally or alternatively directed external to the building structure, such as via building ductwork), and a fan or blower. The range hood 302 can include a controller circuit 308, such as can include a microprocessor circuit, a microcontroller circuit, embedded controller or hardware, software, or firmware. The range hood 302 can include one or more sensors, such as shown and described elsewhere herein, such as with respect to FIG. 1. The range hood 302 can optionally include an integrated microwave or other oven 312, such as described elsewhere herein. The range hood 302 can include a graphical or other local user interface 314, such as described elsewhere herein. The range hood can include a wired or wireless communication interface 316, such as described elsewhere herein, which can be communicatively coupled to a cooking appliance interface circuit 318 that can be located at the cooking appliance 304, such as for interfacing with one or more of one or more heating elements 320 of the cooking appliance 304, one or more heat or fuel controllers or regulators 322 of the cooking appliance 304, or one or more sensors 324 of the cooking appliance 304 (e.g., such as an inductive sensor, a flow sensor, or other cooking appliance sensor, such as described elsewhere herein).

The communication interface 316 can be configured to additionally or alternatively communicate, via a wired or wireless medium, directly or indirectly with an ancillary component that can be included in or coupled to the system 300, such as one or more of: a local/remote user interface 326 (such as described elsewhere herein, e.g., a laptop, a smart phone application (“app”), or other device that can potentially be located or moved elsewhere within or outside of the building, such as away from the range hood 302); a network interface 328 (such as described elsewhere herein, e.g., a wireless router, a wired modem, etc., such as for communicating with a local area network, such as a home network, or a wide area network, such as an internet); a home fire alert system 330 (such as described herein, for example, a First Alert® or other such system); or a local/remote home security or home monitoring system 332 or service (such as described herein). In an example, one or more of such ancillary components (e.g., the local/remote user interface 326, the network interface 328, the fire alert system 330, or the security system 332) can communicate directly or indirectly with one or more of the other such ancillary components or with one or more of the communication interface 316 or the cooking appliance interface 318.

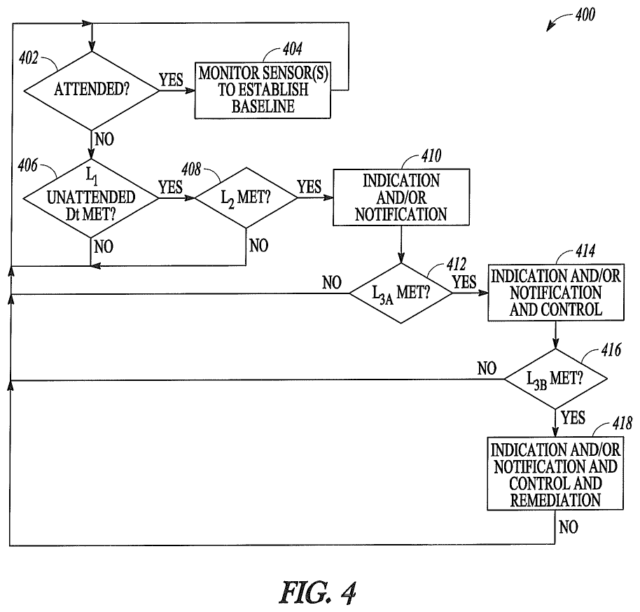

FIG. 4 shows an example of a technique 400, similar to that described with respect to FIG. 2, for using the system 300 to provide a multi-level staged response to varying severity events during unaccompanied cooking, together with a technique for establishing one or more baseline sensor values(s) for use in determining event occurrences.

At 402, when the cooking appliance interface 318 indicates that at least one heating element of the cooking appliance 304 is turned on, such that cooking is underway, the system 300 can determine whether the cooking is attended. If so, then at 404, one or more of the sensors 306 of the range hood or the sensors 324 of the cooking appliance 304 can be monitored during such attended cooking to establish respective baseline values for such sensor(s) that, in an example, can be deemed “within normal cooking parameters” because it is occurring during such attended cooking.

Subsequently, such as during a detected undetected cooking episode, one or more subsequent deviations from normal cooking parameters (e.g., raw difference from baseline, percentage difference from baseline, etc.) that meets a corresponding individual threshold (or a scaled linear combination or other weighted combination of multiple sensor values that meets a corresponding combined threshold) can be used to indicate an abnormal cooking condition, including, for example, an abnormal pre-ignition cooking condition.

At 406, sensor information from a motion detector or other proximity sensor 102 of the sensors 310 associated with the range hood 302 or the sensors 324 associated with the cooking appliance 304 can be used to determine whether a cook or other user is present in the vicinity of the cooking appliance. This can include the controller circuit 308 including a timer circuit that can be started or re-started upon a detected change in occupancy from present to not present. The timer circuit can count the elapsed time since the cook or other user was last determined to be present. The elapsed time can be compared to an unattended time threshold value at 406. If the elapsed time does not exceed the unattended time threshold value, then process flow can return to 402.

At 408, if the elapsed time does exceed an unattended time threshold value at 406, then condition of one or more of the sensors 310, 324 can be tested, either individually or in a specified weighted or other combination. In an example, this can include determining whether an L₂ condition is present, such as described herein, including with respect to FIG. 2. The L₂ condition can indicate an abnormal pre-ignition cooking condition, such as where the controller circuit 308 determines that the specified one or more sensor parameters is outside of a normal range, such as described herein, including with respect to FIG. 2. This L₂ condition can be declared when a specified one or more sensor parameter deviations from one or more corresponding baseline values exceeds a specified raw or percentage difference from its baseline value. If the L₂ condition is met at 408, then a response can be triggered at 410, otherwise process flow can return to 402.

At 410, the response to the L₂ condition that can be triggered can include providing a local Indication (e.g., at the range hood 302 or at the cooking appliance 304), a local/remote Indication (e.g., a Notification via a local/remote user interface 326 or another ancillary device), or both. Then, process flow can continue to 412, as shown, or can return to 402 to recheck whether the cooking has changed from unattended to attended.

At 412, condition of one or more of the sensors 310, 324 can be tested, either individually or in a specified weighted or other combination. The sensors tested at 412 can be the same one or more sensors 310, 324 tested at 408, or a different one or more sensors 310, 324. In an example, this can include determining whether an L_{3A} condition is present, such as described herein, including with respect to FIG. 2. The L_{3A} condition can use one or more different criteria than the L₂ condition, such that the L_{3A} condition can indicate abnormal pre-ignition cooking conditions that are deemed indicative of (1) imminent fire at the cooking appliance 304, (2) unacceptably high CO levels, or both. This L_{3A} condition can be declared when a specified one or more sensor parameter deviations from one or more corresponding baseline values exceeds a specified raw or percentage difference from its baseline value. If the L_{3A} condition is met at 412, then a response can be triggered at 414, otherwise process flow can return to 402.

At 414, the response to the L_{3A} condition that can be triggered can include providing a local Indication (e.g., at the range hood 302 or at the cooking appliance 304), a local/remote Indication (e.g., via a local/remote user interface 326 or another ancillary device), or both. A control signal (“C”) can also be issued, such as to one or both of the range hood 302 or the cooking appliance 304, such as via the communication interface 316 such as to adjust a ventilation parameter (e.g., fan speed, etc.) of the range hood 302, or to reduce, terminate, or otherwise adjust a heat or fuel provided at the cooking appliance 304. The control signal (“C”) can additionally or alternatively be provided to one or more other ventilation, home security, or other same-home device, such via the network interface 328, the fire alert system 330, or the security system 332. Such other same-home devices can include, for example, one or more exhaust fans that can be located away from the cooking appliance, one or more garage door openers, one or more make-up air vents/dampers such as can be associated with the home's HVAC system, etc. For example, if the control signal C is used to increase a fan speed of the range hood 302, than one or more make-up air vents/dampers can be adjusted such as to permit additional make-up air inflow into the home. Then, process flow can continue to 416, as shown, or can return to 402 to recheck whether the cooking has changed from unattended to attended.

At 416, condition of one or more of the sensors 310, 324 can be tested, either individually or in a specified weighted or other combination. The sensors tested at 416 can be the same one or more sensors 310, 324 tested at 408 or 412, or a different one or more sensors 310, 324. In an example, this can include determining whether an L_{3B} condition is present, such as described herein, including with respect to FIG. 2. The L_{3B} condition can use one or more different criteria than the L₂ and L_{3A} condition, such that the L_{3B} condition can indicate abnormal cooking conditions that are deemed indicative of (1) actual fire present at the cooking appliance 304, (2) unacceptably high CO levels, or both. This L_{3B} condition can be declared when a specified one or more sensor parameter deviations from one or more corresponding baseline values exceeds a specified raw or percentage difference from its baseline value. If the L_{3B} condition is met at 416, then a response can be triggered at 418, otherwise process flow can return to 402.

At 418, the response to the L_{3B} condition that can be triggered can include providing a local Indication (e.g., at the range hood 302 or at the cooking appliance 304), a local/remote Indication (e.g., via a local/remote user interface 326 or another ancillary device), or both. At 418, a control signal (“C”) can additionally or alternatively be issued (such as described herein, including with respect to FIG. 2) such as to one or both of the range hood 302 or the cooking appliance 304, such as to adjust a ventilation parameter (e.g., fan speed, etc.) of the range hood 302, or to reduce, terminate, or otherwise adjust a heat or fuel provided at the cooking appliance 304. The control signal “C” issued at 418 can differ from the control signal “C” issued at 414. As an illustrative example, at 414, the control signal “C” can trigger an increase in fan speed and make-up air vent/damper airflow, while at 418 the control signal “C” can shut off the fan and the make-up air vent/damper airflow. At 418, a remediation signal (“R”) can be provided (such as described herein, including with respect to FIG. 2), such as to shut off the fuel or heat source of the cooking appliance 304, to activate a chemical or mechanical fire retardant system (e.g., a portion of which can be included in the range hood 302 or nearby), control a parameter of the ventilation system 306 (e.g., fan speed), notify a home security monitoring service, such as via the security system 332, or a combination of these remediation responses. Then, process flow can return to 402 to recheck whether the cooking has changed from unattended to attended (as shown) or can return to 416 to continue to monitor whether the L_{3B} condition is still present.

### Further Sensor Technology Examples

The present inventors have recognized, among other things, that before ignition of a flame, several environmental changes can occur that can be considered as signs that a fire is imminent. These changes can include a change in temperature, humidity, carbon monoxide, carbon dioxide gas concentration, oxygen gas concentration, an increase in the formation of smoke particulates, an increase in the formation of volatile organic compounds (VOCs). The present inventors have recognized that a variety of sensors can be used to monitor these environmental characteristics. These are outlined as follows and described further below and elsewhere in this document.

Some examples of the sensors 310, 324 that can be used in the system 300 can include, among others: a VOC sensor; a temperature sensor (e.g., non-optical, optical (e.g., infrared), etc.); a humidity sensor (capacitive, resistive, thermal conductivity, etc.); a smoke sensor (e.g., ionization, photoelectric, etc.); a carbon monoxide (CO) sensor (e.g., biomimetic, electrochemical, semiconductor, etc.); a carbon dioxide (CO₂) sensor (e.g., non-dispersive infrared, chemical, solid-state, etc.); an oxygen sensor (e.g., galvanic, paramagnetic, polarographic, zirconium oxide, etc.); or a motion sensor (e.g., passive, active, etc.).

### VOC Sensors

Numerous organic compounds can be identified in cooking emissions, such as including one or more aldehydes, alcohols, ketones, phenols, alkanes, alkenes, alkanoic acids, carbonyls, PAHs, and aromatic amines. The exact compounds emitted and their levels can vary by a number of factors, such as including the type of food or cooking method. For example, a study measuring the type and concentration of volatile organic compounds (VOCs) generated during roasting of pork in an electric oven detected between 61 and 154 different VOCs, depending on the cooking temperature utilized.

In an example, the one or more sensors 306 or the one or more sensors 324 can include one or more VOC sensors, which can be configured to detect multiple substances simultaneously. For example, one sensor can concurrently detect methane, carbon monoxide, natural gas, alcohols, ketones, amines, organic acids, as well hydrocarbon-based substances. Another sensor can concurrently detect carbon monoxide, ethanol, hydrogen, ammonia, and methane. The output from a VOC sensor can be a single value such as can be derived through a sensor-specific technique of combining one or more contributions from an number of contributing gases. A VOC sensor can provide a particular sensor output indicative derived from a large number of possible combinations of gases. Therefore, multiple cooking scenarios can lead to a like sensor output. Therefore, a VOC sensor can be made more useful in combination with another sensor output, such as to help detect an imminent fire from the complex assortment of VOCs that can be emitted during cooking.

Although the technique shown in FIG. 4 has emphasized use of a control signal “C” to the range hood 302, the cooking appliance 304, or another device being made in response to a triggering condition being met, information from one or more of the sensor(s) 310, 324 or the ancillary devices 326, 328, 330, 332 can additionally or alternatively be used to provide a control signal to the range hood 302, the cooking appliance 304, or another device even when the triggering condition is not met. As an illustrative example, information from a particle sensor 112 can additionally or alternatively be used to automatically turn on or adjust the ventilation system 306 of the range hood 302 even when the L_{3A} condition is not met.

Moreover, additional or alternative triggering criteria can be used, such as with the technique of FIG. 4. As an illustrative example, the technique shown in FIG. 4 can itself be triggered by the detection of a cooking event underway, either via the one or more sensors 324 or via a status signal provided by one or more of the heating element 320, or the heat/fuel control circuit 322, or other signal provided by the cooking appliance 304, such as via the cooking appliance interface 318 or otherwise. Thus, the determination at 402 of whether the cooking is attended can be performed contingently on a determination that cooking is occurring.

### Temperature Sensors

In an example, the one or more sensors 306 or the one or more sensors 324 can include one or more non-optical temperature sensors (e.g., a resistance temperature detector (RTD), a thermocouple, a thermistor, etc.), such as can be used to measure the air temperature over the cooking range top or a particular portion thereof. In an example, the non-optical temperature sensor can include a thermocouple, such as can be used for, among other things, measuring the temperature of the incoming air into the range hood ventilation system 306. This type of sensor may require relatively no maintenance or cleaning with a low occurrence for false alarms. It is also relatively low cost.

In an example, the one or more sensors 306 or the one or more sensors 324 can additionally or alternatively include one or more non-optical temperature sensors, such as an infrared temperature sensor device, which can be located at the range hood 302 and placed in view of the range top or other cooking appliance 304. This type of sensor may be prone to false alarms as the result of high temperature cooking or external infrared signals. Additional cleaning of the sensor may be needed and some replacement or maintenance may be needed.

In an example, the range hood 302 can include at least one of a thermocouple or a thermistor, such as can be arranged or otherwise configured to measure the temperature of the air over the cooktop, together with an infrared temperature sensor, which can be arranged or otherwise for measurement of the temperature of the cooktop of the cooking appliance 304 such as from a location at the range hood 302. To improve the accuracy of the cooktop temperature data collected, the infrared sensor's field of view can be limited, such as to less than an angle value that can be between 5 degrees and 10 degrees.

### Humidity Sensors

In an example, the one or more sensors 306 at the range hood 302 or the one or more sensors 324 at the cooking appliance can include one or more humidity sensors, such as can include one or more of a capacitive humidity sensor, a resistive humidity sensor, or a thermal conductivity humidity sensor. In an example, the capacitive humidity sensor can include a substrate on which a thin film of polymer or metal oxide has been deposited between two conductive electrodes. The sensing surface can be coated with a porous metal electrode, such as to protect it from contamination or condensation. A capacitive humidity sensor can function at high temperatures, can exhibit full recovery from condensation, and can provide reasonable resistance to chemical vapors. A resistive humidity sensor can measure the change in electrical impedance of a medium, such as a hygroscopic medium, such as a conductive polymer, salt, or treated substrate. A resistive humidity sensor can exhibit a temperature dependency, and therefore can benefit from temperature compensation by a temperature sensor that can be included in the system 300 and located at or near the resistive humidity sensor, such as at the range hood 302. A thermal conductivity humidity sensor can be arranged or otherwise configured to measure absolute humidity, such as by quantifying a difference between a thermal conductivity of dry air and that of air containing water vapor. An absolute humidity sensor can provide a greater resolution humidity measurement at temperatures exceeding 93° C. than capacitive or resistive humidity sensors, and may be used in a harsher environment where a capacitive or resistive humidity sensor may not survive. A thermal conductivity humidity sensor can perform well in a corrosive environment and at a high temperature.

### Smoke Sensors

In an example, the one or more sensors 306 at the range hood 302 or the one or more sensors 324 at the cooking appliance can include one or more smoke sensors, such as can include one or more of an ionization smoke sensor, a photoelectric smoke sensor, or the like. The ionization smoke sensor can include a small amount of radioactive material between two electrically charged plates, which ionizes the air and results in current flow between the plates. When smoke enters the chamber it disrupts the flow of ions, thus reducing the flow of current and triggering a responsive alert or other action. However, cooking particles entering the ionization chamber can also attach themselves to the ions and cause a reduction in electric current, thereby potentially resulting in a false alarm. The photoelectric smoke sensor can focus a light source into a sensing chamber, such as at an angle away from the sensor. When smoke enters the chamber, it can reflect light onto the light sensor. It is possible for cooking particles to enter the photo chamber and cause the light to scatter onto the photocell triggering a false alarm, but with less likelihood than an ionization-type smoke detector near (e.g., at a distance of 3 feet) the cooking appliance).

### Carbon Monoxide Sensors

In an example, the one or more sensors 306 at the range hood 302 or the one or more sensors 324 at the cooking appliance can include one or more carbon monoxide (CO) sensors, such as can include one or more of a biomimetric CO sensor, an electrochemical CO sensor, or a semiconductor CO sensor. The biomimetric CO sensor can use a gel coated disc that can change color or darken in the presence of carbon monoxide, such as proportional to the amount of carbon monoxide in the surrounding environment. A color recognition sensor can be included and configured to recognize a specified color change and, when detected, can trigger an alert or other response. The electrochemical CO sensor can include a type of a fuel cell that can be configured to produce a current that can be relatively precisely related to the amount of the carbon monoxide in the surrounding environment. Measurement of the current gives a measure of the concentration of carbon monoxide in surrounding environment, a specified change in which, when detected, can trigger an alert or other response. The semiconductor CO detector can include an electrically powered sensing element that can be monitored by an integrated circuit, such as the controller circuit 308. The CO sensing element can include a thin layer of tin dioxide that can be placed over a ceramic. Oxygen can increase the electrical resistance of the tin dioxide while carbon monoxide can reduce the electrical resistance of tin dioxide. The integrated circuit monitors the resistance of the sensing element, and a specified change in resistance corresponding to a specified change in CO can be used to trigger an alert or other response. Electrochemical carbon monoxide sensors, which are chemically resistant, stable during temperature and humidity fluctuations, and have fast response times, are believed most suitable to the present range hood system.

### Carbon Dioxide Sensors

In an example, the one or more sensors 306 at the range hood 302 or the one or more sensors 324 at the cooking appliance can include one or more carbon dioxide (CO₂) sensors, such as can include one or more of a non-dispersive infrared CO₂ sensor, a chemical CO₂ sensor, or a solid-state CO₂ sensor. The non-dispersive infrared (NDIR) CO₂ sensor can include a spectroscopic sensor that can detect carbon dioxide in a gaseous environment such as by its characteristic absorption. The gas can enter a light tube and accompanying electronics can be used to measure the absorption of the wavelength of the light. The chemical CO₂ sensor can measure a pH change in an electrolyte solution caused by the hydrolysis of carbon dioxide, but can experience both short and long term drift effects as well as a low overall usable lifetime compared to NDIR CO₂ sensor technology. The solid state CO₂ sensor can include a potentiometric measuring of CO₂ using a silver halide solid state electrolyte, but with less accuracy compared to NDIR CO₂ sensor technology.

### Oxygen Sensors

In an example, the one or more sensors 306 at the range hood 302 or the one or more sensors 324 at the cooking appliance can include one or more oxygen sensors, such as can include one or more of a galvanic oxygen sensor, a paramagnetic oxygen sensor, a polarographic oxygen sensor, or a zirconium oxide oxygen sensor. The galvanic oxygen sensor, also referred to as an ambient temperature electrochemical sensor, can include two dissimilar electrodes that can be immersed in an aqueous electrolyte. These sensors can exhibit a limited lifetime, which can be reduced by exposure to high concentrations of oxygen. The paramagnetic oxygen sensor can use oxygen's relatively high magnetic susceptibility to determine oxygen concentration. The paramagnetic oxygen sensor can have a good response time, sensor life, and precision over a range of 1% to 100%, but are not recommended for trace oxygen measurements. Contamination of these sensors, such as by dust, dirt, corrosives or solvents can lead to deterioration. The polarographic oxygen sensor can include an anode and cathode that can be immersed in an aqueous electrolyte. The zirconium oxide oxygen sensor can include a solid state electrolyte that can be fabricated from zirconium oxide. These sensors demonstrate excellent response time characteristics, but are not recommended for trace oxygen measurements when reducing gases, including carbon monoxide, are present. For zirconium sensors the sample gas should be heated to the zirconium sensor's operating temperature of approximately 650° C., which may be impractical. Accordingly, a galvanic oxygen sensor, which is CO, CO₂, and vibration resistant, is believed to be the best choice for inclusion in the present system 300.

### Motion Sensors

In an example, the one or more sensors 306 at the range hood 302 or the one or more sensors 324 at the cooking appliance can include one or more passive or active motion or other user proximity sensors, which can provide information about unattended cooking that can have a substantial impact on mitigating cooking fires, as the absence of a cook can be a primary factor contributing to ignition of home cooking fires. The motion sensor can be configured to detect the absence or presence of cook or other user. A motion sensors can have an impact on the behavior of the cook if used to treat unattended cooking as an indication for potential flaming ignition. The passive motion sensor can include an infrared detector to detect differences in heat. A passive motion sensor is expected to provide about a 10 year useful life, but does not have a very wide field of view, and may be susceptible to grease buildup. An active motion sensor can use microwave, ultrasonic, or radio frequency energy to detect motion. Ultrasonic systems can be affected by the build-up of grease or oil on the sensor surface. Microwave and radio frequency sensors are not significantly affected by the presence of grease on their surfaces. Active motion sensors are expected to provide about a 10 year useful life. Both active and passive motion sensors have the potential for false actuation, such as from a large pet or child, which could trigger the motion sensor even if no one was attending to the cooking process.

### Sound/Microphone

In an example, the one or more sensors 306 at the range hood 302 or the one or more sensors 324 at the cooking appliance can include a microphone, such as to monitor the sound environment in the cooking area. The frequency profiles of various events can be detected and used in the sensor algorithm. For instance, specific cooking events (e.g., frying, boiling, etc.), the presence of fire, or even human presence can have a particular frequency profile that can be recognized and distinguished from other such events, and the information used alone or together with other information to trigger a response.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A home kitchen range hood system for a cooking appliance, the system comprising:
a range hood comprising a ventilation system, the ventilation system including an inlet, an outlet, and a fan or blower;
a user proximity sensor, located at or in communication with the range hood, the user proximity sensor arranged to detect the presence or absence of a user in a specified area near the cooking appliance and including a proximity sensor output providing a signal including information about whether the user is present in the specified area near the cooking appliance;
a cooking parameter sensor, located at or in communication with the range hood, the cooking parameter sensor including a cooking parameter sensor output;
a controller circuit, located at or in communication with the range hood, the controller circuit coupled to the at proximity sensor and the cooking parameter sensor, the controller circuit comprising:
a timer circuit, coupled to the proximity sensor output, the timer circuit arranged to compute an elapsed time since the user was detected to be present in the specified area near the cooking appliance;
a comparator circuit, coupled to the timer circuit, the comparator circuit arranged to compare the elapsed time to a specified threshold elapsed time value, the comparator circuit including a comparator output including an unattended cooking indication when an absence of the user from the specified area near the cooking appliance during a cooking episode indicated by the exceeds the specified threshold elapsed time value; and
wherein the controller circuit includes instructions performed in response to the unattended cooking indication to use to cooking parameter sensor output to determine whether
(1) a first condition is present, indicating unattended cooking being outside a normal cooking parameter range without a cooking fire being present; and
(2) a second condition is present indicating a cooking fire being present or a dangerous gas concentration being present.

2. The system of claim 1, wherein the cooking parameter sensor is located at the range hood, and wherein the cooking parameter sensor includes a heat sensor, a particle sensor, and a gas concentration sensor.

3. The system of claim 1, wherein the controller circuit includes instructions performed during attended cooking to establish at least one baseline value for the cooking parameter sensor, wherein the normal cooking parameter range is determined by the controller circuit using the baseline value.

4. The system of claim 1, wherein the range hood includes a communication interface circuit arranged to communicate with a cooking appliance interface to control at least one of heat provided by the cooking appliance or fuel provided to a heating element portion of the cooking appliance, using information about the unattended cooking indication.

5. The system of claim 1, wherein the cooking appliance includes at least one cooking parameter sensor having an output that is adapted to be communicatively coupled to the controller circuit, wherein the controller circuit is located at the range hood.

6. The system of claim 5, wherein the cooking appliance includes at least one cooking parameter sensor including at least one of:
an inductive sensor;
or a flow sensor.

7. The system of claim 1, including:
a local user interface at the range hood;
a local/remote user interface; and
a communication interface circuit, at the range hood, adapted to be communicatively coupled to the local/remote user interface.

8. The system of claim 1, wherein the cooking parameter sensor includes a plurality of:
a digital imaging sensor;
a particle sensor;
a chemical sensor;
a sound sensor;
a humidity sensor; and
a heat sensor; and
wherein the controller circuit includes instructions performed in response to the unattended cooking indication to use to cooking parameter sensor outputs from the plurality of cooking sensors to determine at least one of (1) whether the first condition is present, indicating unattended cooking being outside a normal cooking parameter range without a cooking fire being present; or (2) whether the second condition is present indicating a cooking fire being present or a dangerous gas concentration being present.

9. The system of claim 1, including:
a local indicator at the range hood;
a local/remote indicator adapted to be positioned at a location away from the range hood;
a cooking appliance control interface, adapted to control at least one operating parameter of the cooking appliance associated with the range hood; and
a fire or gas remediation device, located at the range hood.

10. A method of operating a home kitchen range hood system for a cooking appliance, the method comprising:
providing a range hood comprising a ventilation system including an inlet, an outlet, and a fan or blower;
providing a panic button in communication with the range hood;
detecting the presence or absence of a user in a specified area near the cooking appliance during a cooking episode;
providing information about whether the user is present in the specified area near the cooking appliance during the cooking episode;
sensing a cooking parameter;
computing an elapsed time since the user was detected to be present in the specified area near the cooking appliance;
generating an unattended cooking indication when an absence of the user from the specified area near the cooking appliance exceeds a specified threshold elapsed time value;
determining whether a first condition is present, wherein the first condition is present when the unattended cooking indication is generated, the sensed cooking parameter is outside a predetermined cooking parameter range, and no cooking fire is present;
providing a first alert if the presence of the first condition is determined, the panic button including a manual activation to turn off the first alert;
determining whether a second condition is present, wherein the second condition is indicative of a cooking fire being imminent, a cooking fire being present or a predetermined gas concentration being present; and
providing a second alert if the presence of the second condition is determined, wherein the second alert includes closing a fuel source for the cooking appliance or initiating an active fire retardant system, wherein the panic button cannot turn off the second alert.

11. The method of claim 10, wherein sensing the cooking parameter is performed at the range hood, and wherein sensing the cooking parameter includes sensing heat, sensing particles, and sensing a gas concentration.

12. The method of claim 10, including:
establishing at least one baseline value for the cooking parameter sensor; and
determining the predetermined cooking parameter range using the baseline value.

13. The method of claim 10, including communicating from the range hood to the cooking appliance to control at least one of heat provided by the cooking appliance or fuel provided to a heating element portion of the cooking appliance, using information about the unattended cooking indication.

14. The method of claim 10, including sensing at least one cooking parameter at the cooking appliance and communicating resulting information to the range hood.

15. The system of claim 14, wherein the sensing the at least one cooking parameter at the cooking appliance comprises sensing at least one of:
an inductance;
or a flow.

16. The method of claim 10, wherein the first alert or the second alert is provided at least one of:
at the range hood and displaced from the range hood.

17. The method of claim 10, wherein sensing the cooking parameter includes a plurality of:
sensing a digital image;
sensing a particle;
sensing a chemical;
sensing a sound;
sensing a humidity; and
sensing heat; and
using the plurality of sensed cooking parameters, determining at least one of whether the first condition or the second condition is present.

18. The method of claim 10, including:
providing a local indicator at the range hood upon determining the presence of the first condition or the second condition;
providing a local/remote indicator adapted to be positioned at a location away from the range hood upon determining the presence of the first condition or the second condition;
controlling at least one operating parameter of the cooking appliance via the range hood; and
providing a fire or gas remediation at the range hood.

19. The method of claim 10, comprising:
determining whether cooking is occurring; and
when cooking is determined to be occurring, performing the act of detecting the presence or absence of a user in a specified area near the cooking appliance and providing information about whether the user is present in the specified area near the cooking appliance during the cooking.

20. The method of claim 10, including communicating from the range hood to a remote device to control at least one operating parameter of the remote device, using information about the unattended cooking indication.

21. A method of operating a home kitchen range hood system for a cooking appliance, the method comprising:
providing a range hood comprising a ventilation system including an inlet, an outlet, and a fan or blower;
providing a panic button in communication with the range hood;
detecting the presence or absence of a user in a specified area near the cooking appliance during a cooking episode;
providing information about whether the user is present in the specified area near the cooking appliance during the cooking episode;
sensing a cooking parameter;
computing an elapsed time since the user was detected to be present in the specified area near the cooking appliance;
generating an unattended cooking indication when an absence of the user from the specified area near the cooking appliance exceeds a specified threshold elapsed time value;
determining whether a first condition is present, wherein the first condition is indicative of unattended cooking outside a predetermined cooking parameter range without a cooking fire being present, and determining whether a second condition is present, wherein the second condition is indicative of the presence of a cooking fire or a predetermined gas concentration; and
providing a first alert if the presence of the first condition is determined and a second alert if the second condition is determined, the panic button including a manual activation to turn off the first alert.
